(19) United States
(12) Patent Application Publication
(10) Pub. No.: US 2008/0052947 A1
(43) Pub. Date: Mar. 6, 2008

(54) SUBSTRATE PROCESSING METHOD AND SUBSTRATE PROCESSING APPARATUS

(76) Inventor: Katsuhiko Miya, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/837,681

(22) Filed: Aug. 13, 2007

(30) Foreign Application Priority Data
Aug. 29, 2006 (JP) 2006-231612

(51) Int. Cl. F26B 5/08; F26B 11/08

(52) U.S. Cl. 34/317; 34/312; 34/314; 34/319; 34/444; 34/58; 34/611

(57) ABSTRACT

After rinsing, a liquid mixture (IPA+DIW) is supplied to a substrate surface while rotating a substrate at a first rotating velocity which is relatively high to thereby replace the rinsing liquid adhering to the substrate surface with the liquid mixture. In this way, the rinsing liquid adhering to the gaps between the patterns formed on the substrate surface is replaced with the liquid mixture. Subsequently, DIW is supplied to the substrate surface in a condition that the rotation of the substrate is stopped or that the substrate is rotated at a second rotating velocity which is relatively low to thereby form a puddle-like liquid layer with DIW. In this way, the liquid mixture of the surface layer part is removed from the substrate surface while leaving almost all the liquid mixture adhering to the gaps between the patterns. After that, the liquid layer is removed from the substrate surface to thereby dry the substrate surface.

### CROSS REFERENCE TO RELATED APPLICATION

The disclosure of Japanese Patent Application No. 2006-231612 filed Aug. 29, 2006 including specification, drawings and claims is incorporated herein by reference in its entirety.

### BACKGROUND OF THE INVENTION

1. Field of the Invention

The present invention relates to a substrate processing method of and a substrate processing apparatus for drying a substrate surface which is wet with a processing liquid. Substrates to be dried include semiconductor wafers, glass substrates for photomask, glass substrates for liquid crystal display, glass substrates for plasma display, substrates for FED (Field Emission Display), substrates for optical disks, substrates for magnetic disks, substrates for magnet-optical disks, etc.

2. Description of the Related Art

Numerous drying methods have already been proposed which aim at removal of a rinsing liquid adhering to a surface of a substrate after chemical processing using a chemical solution and rinsing processing using a rinsing liquid which may be deionized water or the like. Known as one such method is a drying method which uses liquid (that is, low surface tension solvent) which contains an organic solvent component whose surface tension is lower than that of deionized water such as IPA (isopropyl alcohol). As this drying method, there is a drying method described in JP-A-2003-168668. A substrate processing apparatus which executes this drying method is an apparatus which spin-dries a substrate which has been performed chemical processing and rinsing processing. In this apparatus, chemical processing is followed by rinsing processing during which a two fluid mixing nozzle supplies to a substrate surface a nitrogen gas and IPA-contained deionized water which is prepared by mixing IPA with deionized water. This removes a chemical solution and particles adhering to a substrate surface, and suppresses generation of watermarks on the substrate surface during drying.

Further, in a substrate processing apparatus described in JP-A-7-122485, after developing processing is performed to the substrate surface on which resist pattern is formed, an IPA solution which is obtained by mixing IPA with deionized water is supplied to the substrate surface as a rinsing liquid. Thus, rinsing processing is performed to the substrate surface with the IPA solution. Subsequently, heating processing is performed to the substrate and the rinsing liquid is removed from the substrate surface. In this way, while preventing destruction of resist patterns by the execution of rinsing processing with IPA solution, drying of the substrate surface is performed.

### SUMMARY OF THE INVENTION

However, according to the substrate processing apparatus described in JP-A-2003-168668, after chemical processing, the chemical solution and the particles adhering to the substrate surface are removed by supplying IPA-contained deionized water to the substrate surface as a rinsing liquid. Further, in the substrate processing apparatus described in JP-A-7-122485 as well, a resist after development and a liquid developer which remains adhering to the substrate surface are removed using the IPA solution as a rinsing liquid after developing processing. Hence, a comparable rinsing time is required for removal of a processing liquid (that is, a chemical solution, a liquid developer, etc.) and unwanted substances adhering to the substrate surface, and the consumption amount of IPA accordingly increases. As a result, a lot of IPA is required to process the substrate, which is one of main factors of cost increase.

Further, liquid (that is, low surface tension solvent) which contains IPA and the like whose surface tension is lower than that of deionized water contains more than a little of particles. Therefore, when the liquid which contains IPA and the like is supplied to the substrate before drying, there has occurred a problem that the particles contained in the liquid build up on a substrate and contaminate the substrate surface.

The invention has been made in light of the problems addressed above, and accordingly aims to provide a substrate processing method and a substrate processing apparatus which can dry the substrate surface at low cost in drying the substrate surface which is wet with a processing liquid.

According to a first aspect of the present invention, there is provided a substrate processing method of drying a substrate surface which is wet with a processing liquid, the method comprising: a replacing step of supplying a low surface tension solvent whose surface tension is lower than the processing liquid to the surface of the substrate which is held approximately horizontally to thereby replace the processing liquid adhering to the substrate surface with the low surface tension solvent; a liquid layer forming step of supplying, after the replacing step, a liquid whose composition or principal component is the same as that of the processing liquid to thereby form a puddle-like liquid layer with the liquid on the substrate surface; and a drying step of removing the liquid layer from the substrate surface to thereby dry the substrate surface.

According to a second aspect of the present invention, there is provided a substrate processing apparatus, comprising: a substrate holder which holds a substrate approximately horizontally in a condition that a substrate surface which is wet with a processing liquid is directed toward above; a replacing section which supplies a low surface tension solvent whose surface tension is lower than the processing liquid to the substrate surface to thereby replace the processing liquid adhering to the substrate surface with the low surface tension solvent; and a liquid layer forming section which supplies a liquid, whose composition or principal component is the same as that of the processing liquid, to the substrate surface to which the low surface tension solvent adheres to thereby form a puddle-like liquid layer with the liquid on the substrate surface, wherein the liquid layer is removed from the substrate surface to thereby dry the substrate surface.

Meanwhile, IPA of 100% may be used as the “low surface tension solvent” of the invention other than the liquid mixture described above. Further, as the low surface tension solvent, a solvent which includes a surface acting agent as an essential component may be used instead of the solvent which includes an organic solvent component. At this stage, an alcoholic organic solvent may be used as the “organic solvent component”. While isopropyl alcohol, ethyl alcohol or methyl alcohol may be used in consideration of the safety, the price and the like, isopropyl alcohol (IPA) is particularly suitable.

Further, a puddle-like liquid layer of the invention may be formed on the entire substrate surface or on a part of the substrate surface. At the liquid layer forming step, the liquid layer may be formed on the entire substrate surface to thereby remove most of the low surface tension solvent on the substrate surface from the substrate surface. Further, at the liquid layer forming step, the liquid layer may be formed at a central section of the surface of the substrate, and then, a gas may be blown toward the central section of the surface of the substrate to thereby form the liquid layer in a shape of a ring and enlarge the ring-like liquid layer toward the periphery edge of the substrate from the central section of the surface of the substrate, which leads to removal of most of the low surface tension solvent on the substrate surface from the substrate surface.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing a first embodiment of a substrate processing apparatus according to the invention.

FIG. 2 is a block diagram which shows a main control configuration of the substrate processing apparatus which is shown in FIG. 1.

FIG. 3 is a flow chart which shows an operation of the substrate processing apparatus which is shown in FIG. 1.

FIGS. 4 and 5 are schematic diagrams showing the operation of the substrate processing apparatus which is shown in FIG. 1.

FIG. 6 is a graph of the relationship between the IPA concentration and the surface tension γ.

FIG. 7 is a diagram showing a second embodiment of a substrate processing apparatus according to the invention.

FIG. 8 is a longitudinal sectional view showing a main part of the blocking member equipped in the substrate processing apparatus shown in FIG. 7.

FIG. 9 is a sectional view taken on line A-A in FIG. 8.

FIGS. 10A through 10C are diagrams showing a modification of a substrate processing apparatus according to the invention.

FIG. 11 is a drawing which shows conditions and results of working examples 1 and 2 and comparative examples 1 and 2.

### DETAILED DESCRIPTION OF THE PREFERRED EMBODIMENTS

### First Embodiment

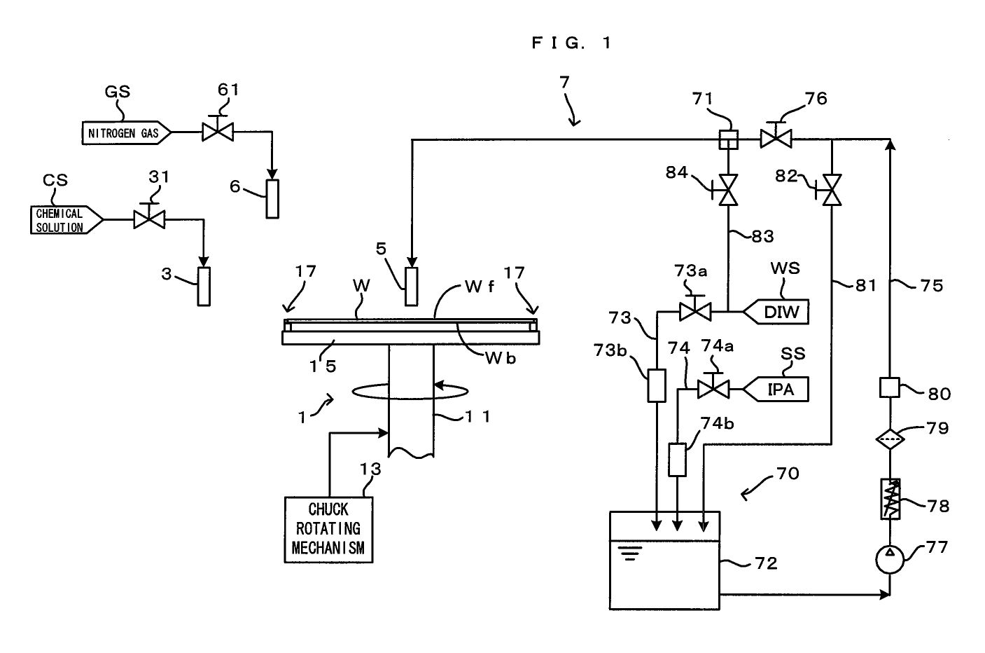

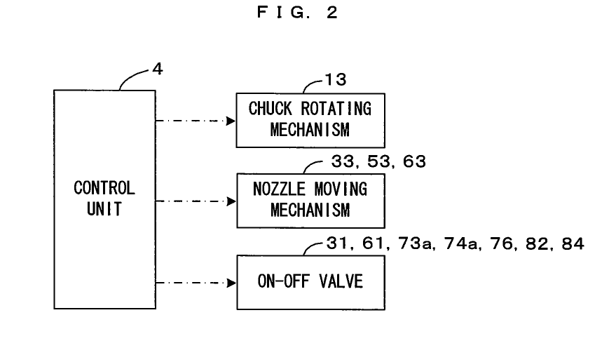

FIG. 1 is a diagram showing a first embodiment of a substrate processing apparatus according to the invention. FIG. 2 is a block diagram which shows a main control configuration of the substrate processing apparatus which is shown in FIG. 1. This substrate processing apparatus is a substrate processing apparatus of the single wafer type which is used in cleaning processing which is for removing undesired substance adhering to a surface Wf of a substrate W such as a semiconductor wafer. To be more exact, this is an apparatus in which after chemical processing with a chemical solution of a hydrofluoric acid or the like and rinsing processing with a rinsing liquid such as purified water or DIW are performed to the substrate surface Wf, the substrate surface Wf which is wet with the rinsing liquid is dried. Meanwhile, in this embodiment, the substrate surface Wf is a pattern-formed surface on which a device pattern is formed.

This substrate processing apparatus comprises a spin chuck 1 which holds and rotates the substrate W approximately horizontally in a condition that the surface Wf is directed toward above, a chemical solution nozzle 3 and a rinse nozzle 5 which supply the chemical solution and the rinsing liquid respectively from above the substrate W which is held by the spin chuck 1, and a gas nozzle 6 which supplies a nitrogen gas from above the substrate W which is held by the spin chuck 1. At this stage, the rinse nozzle 5 is capable of selectively supplying DIW and a liquid mixture to the substrate W, the liquid mixture (that is, low surface tension solvent) being a mixture of DIW and an organic solvent component which gets dissolved in DIW and reduces the surface tension thereof.

A rotation column 11 of the spin chuck 1 is linked to a rotation shaft of a chuck rotating mechanism 13 which contains a motor. The spin chuck 1 is rotatable about a vertical axis when driven by the chuck rotating mechanism 13. A disk-shaped spin base 15 is connected by a fastening component such as a screw to a top end portion of the rotation column 11 as one integrated unit. The spin base 15 therefore rotates about the vertical axis by driving the chuck rotating mechanism 13 in response to an operation command received from a control unit 4 which controls the entire apparatus. Thus, in this embodiment, the chuck rotating mechanism 13 functions as a “rotating unit” of the invention.

Plural chuck pins 17 for holding the substrate W at the rim thereof are disposed upright in the vicinity of the rim of the spin base 15. There may be three or more chuck pins 17 to securely hold the disk-shaped substrate W, and the chuck pins 17 are arranged at equal angular intervals along the rim of the spin base 15. Each chuck pin 17 comprises a substrate support part which supports the substrate W at the rim thereof from below and a substrate holding part which presses the substrate W at the outer peripheral edge surface thereof to hold the substrate W. Each chuck pin 17 is structured so as to be capable of switching between a pressing state that the substrate holding part presses the substrate W at the outer peripheral edge surface thereof and a released state that the substrate holding part stays away from the outer peripheral edge surface of the substrate W.

The plural chuck pins 17 are in the released state while the substrate W is being transferred to the spin base 15 but in the pressing state for cleaning of the substrate W. When in the pressing state, the plural chuck pins 17 hold the substrate W at the rim thereof and keep the substrate approximately horizontally at a predetermined distance from the spin base 15. The substrate W is held with its front surface (pattern-formed surface) Wf directed toward above and its back surface Wb toward below. Thus, in this embodiment, the chuck pins 17 functions as a “substrate holder” of the invention. Meanwhile, the substrate holder is not limited to the chuck pins 17. A vacuum chuck which holds the substrate W by vacuuming a substrate rear surface Wb may be used as the substrate holder.

The chemical solution nozzle 3 is connected with a chemical solution supplying source CS via an on-off valve 31. Hence, when the on-off valve 31 opens or closes based on a control command from the control unit 4, the chemical solution is pressure-fed from the chemical solution supplying source CS toward the chemical solution nozzle 3, and the chemical solution nozzle 3 discharges the chemical solution. Meanwhile, hydrofluoric acid, BHF (buffered hydrofluoric acid), or the like is used as the chemical solution. Further, the chemical solution nozzle 3 is connected with a nozzle moving mechanism 33 (FIG. 2). The nozzle moving mechanism 33 is driven in response to an operation command from the control unit 4, whereby the chemical solution nozzle 3 moves in reciprocation between a discharge position which is above the rotation center of the substrate W and a stand-by position which is off the discharge position to the side. In the similar way, the nozzle moving mechanism 53 (FIG. 2) is connected with the rinse nozzle 5 so that when the nozzle moving mechanism 53 operates in response to an operation command from the control unit 4, the rinse nozzle 5 moves in reciprocation between a discharge position which is above a rotation center of the substrate W and a stand-by position which is off the discharge position to the side.

A liquid supply unit 7, which selectively supplies DIW and the liquid mixture (DIW+the organic solvent component) to the rinse nozzle 5, is connected with the rinse nozzle 5. The liquid supply unit 7 comprises a cabinet part 70 for producing the liquid mixture and is capable of pressure-feeding the liquid mixture produced in the cabinet part 70 to the rinse nozzle 5. The liquid supply unit 7 is also capable of pressure-feeding DIW directly to the rinse nozzle 5. The organic solvent component may be a substance which is dissolved in DIW (whose surface tension is 72 mN/m) and lowers the surface tension, such as isopropyl alcohol (whose surface tension is 21 through 23 mN/m). The organic solvent component is not limited to isopropyl alcohol (IPA), and various types of organic solvent components such as ethyl alcohol and methyl alcohol may instead be used. Further, the organic solvent component is not limited to liquid. Vapor of various types of alcohol may be dissolved as the organic solvent component in DIW to thereby prepare the liquid mixture.

The cabinet part 70 comprises a reservoir tank 72 which holds the liquid mixture of DIW and IPA. The reservoir tank 72 accepts one end of a DIW introducing pipe 73 which is for supplying DIW into inside the reservoir tank 72, and the other end of the DIW introducing pipe 73 is connected via an on-off valve 73a with a DIW supplying source WS which is formed by utilities or the like installed in a plant. Further, a flowmeter 73b is inserted in the DIW introducing pipe 73 and measures the flow rate of DIW which is led to the reservoir tank 72 from the DIW supplying source WS. Based on the flow rate which the flowmeter 73b measures, the control unit 4 controls opening and closing of the on-off valve 73a so that the flow rate of DIW flowing in the DIW introducing pipe 73 would be a target flow rate (target value).

In a similar manner, the reservoir tank 72 accepts one end of an IPA introducing pipe 74 which is for supplying the IPA liquid into inside the reservoir tank 72, and the other end of the IPA introducing pipe 74 is connected via an on-off valve 74a with an IPA supplying source SS. Further, a flowmeter 74b is inserted in the IPA introducing pipe 74 and measures the flow rate of the IPA liquid which is led to the reservoir tank 72 from the IPA supplying source SS. Based on the flow rate which the flowmeter 74b measures, the control unit 4 controls opening and closing of the on-off valve 74a so that the flow rate of the IPA liquid flowing in the IPA introducing pipe 74 would be a target flow rate (target value).

In this embodiment, the flow rates of IPA liquid and DIW introduced into the reservoir tank 72 are adjusted so that a percentage by volume (hereinafter referred to as the “IPA concentration”) of IPA contained in the liquid mixture may be a predetermined value which is in the range of not more than 50%, 10% for instance. By setting the IPA concentration in this way, it is possible to effectively prevent destruction of patterns formed on the substrate surface Wf while suppressing consumption amount of IPA as described hereinafter. Further, it is possible to simplify protection for the apparatus against exposure of IPA as compared to where the IPA concentration is 100%.

The reservoir tank 72 accepts insertion of the other end of a liquid mixture supplying pipe 75 whose one end is connected with a mixing valve 71, so as to supply the liquid mixture stored in the reservoir tank 72 to the mixing valve 71 via an on-off valve 76. In the liquid mixture supplying pipe 75, a constant rate pump 77 which feeds the liquid mixture stored in the reservoir tank 72 to the liquid mixture supplying pipe 75, a temperature adjuster 78 which adjusts the temperature of the liquid mixture which is pumped out by the constant rate pump 77 into the liquid mixture supplying pipe 75, and a filter 79 which removes foreign matters contained in the liquid mixture. In addition, a concentration meter 80 which monitors the IPA concentration, that is, the percentage by volume of IPA contained in the liquid mixture is inserted in the liquid mixture supplying pipe 75.

Further, one end of a liquid mixture circulation pipe 81 branches out from the liquid mixture supplying pipe 75 between the on-off valve 76 and the concentration meter 80, and the other end of the liquid mixture circulation pipe 81 is connected with the reservoir tank 72. An on-off valve 82 is inserted in the liquid mixture circulation pipe 81. During the operation of the apparatus, the constant rate pump 77 and the temperature adjuster 78 are driven all the time. While the liquid mixture is not supplied to the substrate W, the on-off valve 76 is closed, whereas the on-off valve 82 is opened. In this way, the liquid mixture which is pumped out by the constant rate pump 77 from the reservoir tank 72 returns back to the reservoir tank 72 via the liquid mixture circulation pipe 81. In short, when the liquid mixture is not supplied to the substrate W, the liquid mixture circulates in the circulation path composed of the reservoir tank 72, the liquid mixture supplying pipe 75 and the liquid mixture circulation pipe 81. Meanwhile, at the timing for supplying the liquid mixture to the substrate W, the on-off valve 76 is opened and the on-off valve 82 is closed. This provides the mixing valve 71 with the liquid mixture which is pumped out from the reservoir tank 72. Further, the mixing valve 71 is connected with the rinse nozzle 5 so that the liquid mixture supplied to the mixing valve 71 is discharged toward the substrate W from the rinse nozzle 5. In this way, by circulating the liquid mixture while it is not supplied to the substrate W, DIW and IPA get agitated, realizing a state that DIW and IPA are adequately mixed with each other. In addition, it is possible to supply quickly after the on-off valve 76 is opened to the rinse nozzle 5 the liquid mixture whose temperature is adjusted to a predetermined temperature and which is free from foreign matters.

One end of a DIW supplying pipe 83 branches out from the DIW introducing pipe 73 at the upstream side (that is, at the DIW supplying source WS side) to the on-off valve 73a, and the other end of the DIW supplying pipe 83 is connected with the mixing valve 71. An on-off valve 84 is inserted in the DIW supplying pipe 83. According to the structure like this, when the on-off valves 76 and 84 are controlled to open and close in response to a control command from the control unit 4, DIW and the liquid mixture (DIW+IPA) are selectively supplied to the rinse nozzle 5. That is, when the on-off valve 76 closes and the on-off valve 84 opens, DIW is supplied to the rinse nozzle 5 via the mixing valve 71. On the other hand, when the on-off valve 76 opens and the on-off valve 84 closes, the liquid mixture is supplied to the rinse nozzle 5 via the mixing valve 71.

Further, the gas nozzle 6 is disposed above the spin chuck 1. The gas nozzle 6 is connected with a gas supplying source GS via an on-off valve 61. Hence, when the on-off valve 61 opens or closes based on a control command from the control unit 4, nitrogen gas is pressure-fed from the gas supplying source GS toward the gas nozzle 6, and the gas nozzle 6 discharges the nitrogen gas. Further, the gas nozzle 6 is linked to a nozzle moving mechanism 63 (FIG. 2). The nozzle moving mechanism 63 is driven in response to an operation command from the control unit 4, whereby the gas nozzle 6 moves in reciprocation between a discharge position which is above the rotation center of the substrate W and a stand-by position which is off the discharge position to the side. Meanwhile, in this embodiment, although nitrogen gas is supplied from the gas supplying source GS, it may be structured so that air, other inert gas, or the like may be supplied.

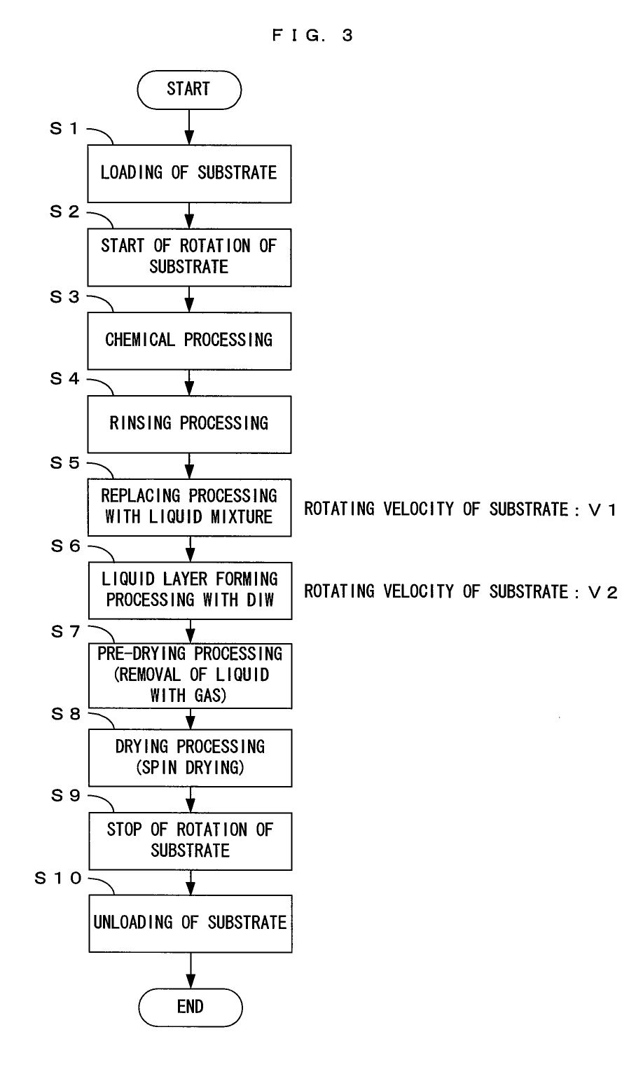

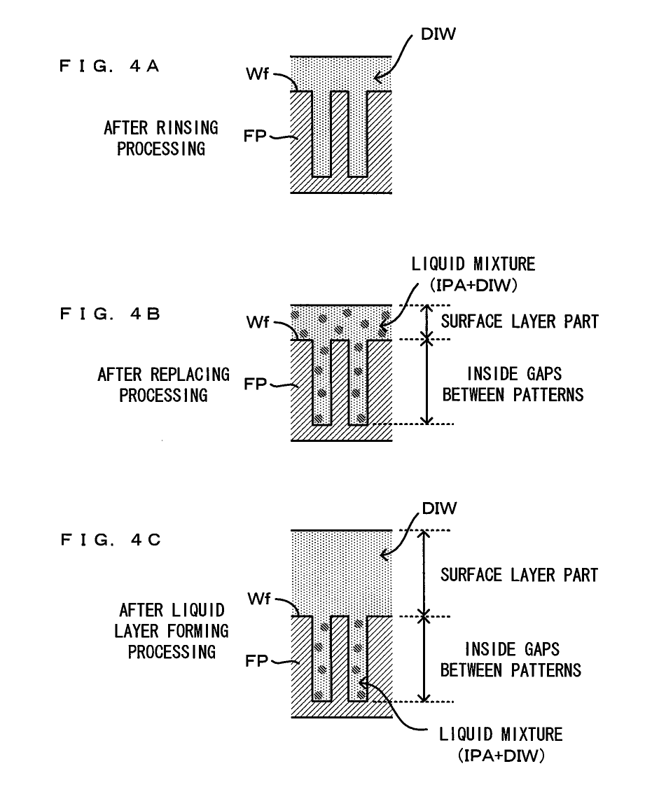

Next, an operation of the substrate processing apparatus structured as described above will now be described with reference to FIGS. 3 through 5. FIG. 3 is a flow chart which shows an operation of the substrate processing apparatus which is shown in FIG. 1. FIGS. 4 and 5 are schematic diagrams showing the operation of the substrate processing apparatus which is shown in FIG. 1. When the substrate transporter (not shown) loads the substrate W yet to be processed into inside the apparatus (Step S1), the control unit 4 controls the individual parts of the apparatus and accordingly cleaning processing (chemical processing+rinsing processing+replacing processing+liquid layer forming processing+drying processing) of the substrate W is performed. Meanwhile, micro patterns made of poly-Si for example are formed on the substrate surface Wf. Noting this, in this embodiment, the substrate W is loaded into the apparatus with the substrate surface Wf directed toward above and is held by the spin chuck 1.

Following this, chemical processing of the substrate W is executed. In other words, the chemical solution nozzle 3 moves to the discharge position, and by driving the chuck rotating mechanism 13, the substrate W held by the spin chuck 1 rotates at a predetermined rotating velocity (which may for example be 500 rpm) (Step S2). Subsequently, when a hydrofluoric acid as the chemical solution is supplied to the substrate surface Wf from the chemical solution nozzle 3, the hydrofluoric acid spreads due to centrifugal force and chemically processes the entire substrate surface Wf (Step S3).

Upon completion of this chemical processing, the chemical solution nozzle 3 moves to the stand-by position. Then rinsing processing of the substrate W is executed. In short, the rinse nozzle 5 moves to the discharge position and the rinsing liquid (DIW) is supplied to the surface Wf of the rotating substrate W from the rinse nozzle 5. This spreads the rinsing liquid due to centrifugal force and the entire substrate surface Wf is consequently rinsed (Step S4; rinsing step). As a result, the hydrofluoric acid adhering to the substrate surface Wf is removed by the rinsing liquid off from the substrate surface Wf. Meanwhile, the rotating velocity of the substrate W during rinsing is set to 30 through 1,000 rpm for instance.

Upon completion of rinsing processing for a predetermined time period, the control unit 4 makes the rinse nozzle 5 discharge the liquid mixture (IPA+DIW) instead of the rinsing liquid while keeping the rotation of the substrate W. Here, in the cabinet part 70, the liquid mixture has been produced in advance so as to have the IPA concentration thereof is adjusted to 10% for instance and the liquid mixture is discharged from the rinse nozzle 5 toward the substrate surface Wf. Further, the rotating velocity of the substrate W is set to a first rotating velocity V1 which is relatively high (that is, not less than 500 rpm for instance). In this embodiment, the substrate W is rotated at 1,000 rpm as the first rotating velocity V1. Thus, relatively large centrifugal force acts upon the liquid mixture supplied to the substrate surface Wf. This makes the liquid mixture on the substrate surface Wf flow violently and accordingly enter into even inside the gaps between the patterns. As a result, the state shown in FIG. 4A is transferred to the state shown in FIG. 4B for instance, that is, the rinsing liquid (DIW) adhering to the gaps between the micro patterns FP is replaced with the liquid mixture without fail (Step S5; replacing step).

By the execution of this replacing processing, it is possible to effectively prevent the destruction of the patterns during the drying processing described hereinafter. To be more specific, the pattern destruction results from the patterns being pulled to each other by a negative pressure developed in gaps between patterns during the execution of the drying processing. And, the magnitude of the negative pressure developed in the gaps between the patterns is dependent upon the surface tension of the liquid which is present in the gaps between the patterns, and the larger the surface tension of the liquid is, the larger the negative pressure is. Therefore, the rinsing liquid adhering to the gaps between the patterns is replaced with the liquid mixture (low surface tension solvent) of which the surface tension is lower than that of the rinsing liquid, whereby the pattern destruction is effectively prevented.

Further, the rinsing liquid adhering to the substrate surface Wf is replaced with the liquid mixture (low surface tension solvent), whereby the generation of watermarks is prevented during the drying processing. The cause of the generation of watermarks is thought to be elution of a substance (silicon in the case of silicon substrate) from the substrate W into the liquid adhering to the substrate W, the substance being a material which is likely to be oxidized (hereinafter called the “substance-likely-to-be-oxidized”). When the amount of elution of the substance-likely-to-be-oxidized into the rinsing liquid (DIW) is compared to that into the liquid mixture, the latter is a lot less than the former. Further, even if the substance-likely-to-be-oxidized is eluted into the liquid mixture from the substrate W, it seldom appears as a stain (defect) since the surface tension of the liquid mixture is lower than that of the rinsing liquid. Therefore, it is possible to suppress generation of watermarks by replacing the rinsing liquid adhering to the substrate surface Wf with the liquid mixture (low surface tension solvent).

On the other hand, when the liquid mixture (IPA+DIW) is supplied to the substrate surface Wf, the substrate surface Wf may be contaminated. To be more specific, the liquid mixture includes particles such as a foreign material which is present in the liquid mixture and a nonvolatile component in IPA, and hence, when the liquid mixture is supplied to the substrate surface Wf, there occurs a problem that particles adhere to the substrate surface Wf. Consequently, in this embodiment, after the replacing processing with the liquid mixture, liquid layer forming processing with DIW is executed as described below, whereby particles are removed from the substrate surface Wf. First, the control unit 4 decreases the rotating velocity of the substrate W to a second rotating velocity V2 which is relatively low (that is, not more than 50 rpm for instance). Subsequently, DIW is discharged from the rinse nozzle 5. Thus, a puddle with DIW is formed in the central part of the substrate surface Wf, and the puddle expands toward the edge of the substrate W. As a result, a puddle-like liquid layer 21 (FIG. 5A) with DIW is formed all over the substrate surface Wf (Step S6; liquid layer forming step). In this liquid layer forming processing, since the rotating velocity of the substrate W is set relatively low, the replacement of the liquid adhering to the gaps between the micro patterns FP with DIW due to the flow of DIW is suppressed. That is, it is possible to prevent the liquid mixture which has got into the inside of the gaps between micro patterns FP from getting away to a surface layer part from the gaps. Hence, only the liquid mixture in the surface layer part is replaced with DIW and removed from the substrate surface Wf, leaving the liquid mixture which is present in the gaps between micro patterns FP as shown in FIG. 4C. Therefore, it is possible to prevent particles contained in the liquid mixture from adhering to the substrate surface Wf. Meanwhile, the rotation of the substrate W is not required in the liquid layer forming processing, and the liquid layer 21 may be formed in a condition that the rotation of the substrate W is stopped.

Thus, in this embodiment, the rinse nozzle 5 which selectively supplies the liquid mixture or DIW to the substrate surface Wf functions as “replacing section” and “liquid layer forming section” of the invention. Meanwhile, supplying the liquid mixture and DIW from a single nozzle is not required, the liquid mixture and DIW may be supplied from respective nozzles which are provided separately.

When the liquid layer 21 is formed on the substrate surface Wf in this way, the rinse nozzle 5 moves to the stand-by position. Further, the substrate W is rotated at the second rotating velocity V2 continuously from the liquid layer forming processing, or the rotation is stopped. Then, a removing processing of the liquid layer 21 from the substrate surface Wf is executed with nitrogen gas. To be more specific, the gas nozzle 6 moves to the discharge position and blows a nitrogen gas toward a central section of the surface of the substrate W. In consequence, as shown in FIG. 5B, a nitrogen gas blown to the substrate surface Wf from the gas nozzle 6 pushes the liquid present in a central part of the liquid layer 21 toward the outer side in the radial direction of the substrate W, whereby a hole 22 is formed in the central part of the liquid layer 21 and this surface portion is dried. Meanwhile, the liquid mixture stays to remain inside the gaps between the patterns.

And, by blowing a nitrogen gas continuously toward a central section of the surface of the substrate W, as shown in FIG. 5C, thus formed hole 22 expands toward the edge of the substrate W (that is, in the horizontal direction in FIG. 5C), the liquid at the center of the liquid layer 21 is gradually pushed away from the center toward the edge of the substrate and the dried region accordingly grows (Step S7; pre-drying step). In this way, most of the liquid which composes the liquid layer 21 is removed from the substrate surface Wf except for the liquid mixture adhering to the inside of the gaps between patterns. In this embodiment, the gas nozzle 6 thus functions as the “gas blower” of the invention.

When the pre-drying step finishes in this way, the control unit 4 enhances the rotating velocity of the substrate W to rotate the substrate W at a high speed (which may for instance be 3,000 rpm). Thus, the liquid component remaining to adhere to the substrate surface Wf is shaken off and drying processing (spin drying) of the substrate W is executed (Step S8; drying step). At this stage, the liquid mixture is present in the gaps between the patterns. It is therefore possible to shorten the drying time and improve the throughput while preventing destruction of the patterns, generation of watermarks, etc. In addition, thus shortened drying time reduces elution of a substance-likely-to-be-oxidized into the liquid component which adheres to the substrate W and further effectively suppresses generation of watermarks. After drying processing of the substrate W ends, the control unit 4 controls the chuck rotating mechanism 13 and stops the substrate W from rotating (Step S9). The substrate transporter thereafter unloads thus processed substrate W from the apparatus, which completes the series of cleaning processing of one substrate W (Step S10).

As described above, according to this embodiment, the rinsing liquid (DIW) adhering to the substrate surface Wf is replaced with the liquid mixture (low surface tension solvent) of which the surface tension is lower than that of the rinsing liquid. Hence, destruction of the patterns and generation of watermarks are prevented in drying the substrate W. Further, the puddle-like liquid layer 21 with the liquid (DIW) whose composition is the same as that of the rinsing liquid is formed on the entire substrate surface Wf after the replacing processing. This removes the liquid mixture of the surface layer part from the substrate surface Wf leaving only the liquid mixture which is present in the gaps between the patterns remaining mostly therein. Therefore, since most of the liquid mixture on the substrate surface Wf is removed from the substrate surface Wf, it is possible to prevent particles from adhering to the substrate surface Wf in drying the substrate W, even if particles are contained in the liquid mixture. Furthermore, since drying of the substrate W starts in the state that the liquid mixture remains in the gaps between the patterns, it is possible to prevent particles from contaminating the substrate surface Wf, while preventing destruction of the patterns and generation of watermarks.

Further, replacing processing with the liquid mixture is executed to the substrate surface Wf which is wet with the rinsing liquid, whereby the consumption amount of IPA is reduced. To be more specific, rinsing step is executed with the rinsing liquid which is composed only of DIW which is different from the liquid mixture (IPA+DIW), whereas in the replacing step, it is only necessary to prepare IPA enough to replace the rinsing liquid adhering to the substrate surface Wf with the liquid mixture, whereby the consumption amount of IPA is suppressed. Further, the puddle-like liquid layer 21 is formed only with DIW without using IPA. Therefore, it is possible to reduce cost by decreasing the consumption amount of IPA required for the process per substrate.

Further, according to this embodiment, replacing processing is executed with the liquid mixture while rotating the substrate W at the first rotating velocity V1, whereas liquid layer forming processing is executed while rotating the substrate W at the second rotating velocity V2 which is lower than the first rotating velocity V1. Hence, the substrate W is rotated at the first rotating velocity V1 which is relatively high, whereby the liquid mixture enters into the inside the gaps between the patterns by means of relatively large centrifugal force which acts upon the liquid mixture. As a result, the rinsing liquid which is present in the gaps between the patterns can be securely replaced with the liquid mixture (low surface tension solvent). On the other hand, the substrate W is rotated at the second rotating velocity V2 which is relatively low (the rotation of the substrate W may be stopped as described above), whereby only the liquid mixture of the surface layer part is removed from the substrate surface Wf while leaving the liquid mixture inside the gaps between the patterns. Therefore, it is possible to securely prevent destruction of the patterns and generation of watermarks in drying the substrate with the liquid mixture adhering to the gaps between the patterns, while preventing adhesion of particles to the substrate surface Wf by removing the liquid mixture of the surface layer part.

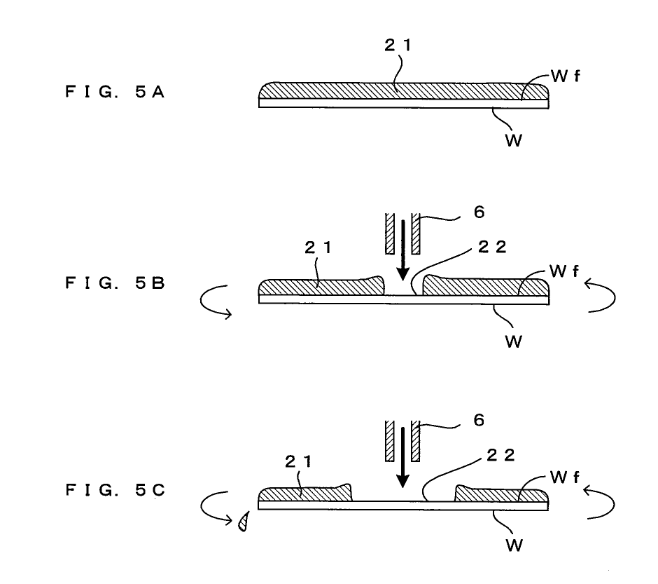

Further, according to this embodiment, since the IPA concentration contained in the liquid mixture is set to 50% or less, it is possible to prevent destruction of the patterns effectively while suppressing the consumption amount of IPA as described below. FIG. 6 is a graph of the relationship between the IPA concentration and the surface tension γ. The horizontal axis in FIG. 6 represents the IPA concentration. The IPA concentration of 0 (vol %) means that the liquid mixture is made only of DIW, whereas the IPA concentration of 100 (vol %) means that the liquid mixture is made only of the IPA liquid. The surface tension γ was measured by the pendant drop method using LCD-400S manufactured by Kyowa Interface Science Co., LTD. As FIG. 6 clearly shows, in accordance with an increase of the mixed amount of IPA in DIW, up to the IPA concentration of around 10%, the surface tension γ of the liquid mixture rapidly decreases as the mixed amount of IPA in DIW increases. Where the IPA concentration is 50% or more, the surface tension of the liquid mixture does not decrease significantly but maintains a value which is approximately equivalent to the surface tension of the IPA liquid alone.

At this stage, in order to prevent destruction of the patterns effectively, it is important to replace the rinsing liquid (DIW) adhering to the gaps between the patterns with a substance (low surface tension solvent) whose surface tension is lower than that of the rinsing liquid. In this case, the above replacing processing may be executed with IPA having the concentration of 100%. However, a relatively great amount of PA is necessary when IPA of 100% is supplied to the substrate surface Wf. Consequently, in terms of suppressing the consumption amount of IPA, supplying a comparatively little amount of IPA and mixing the IPA into DIW is a possibility in the case where IPA of 100% is used. However, when only a comparatively little amount of IPA is supplied to the substrate W, it is difficult to feed IPA into the inside of the gaps between the patterns even if IPA can be mixed into the surface layer part of DIW adhering to the substrate surface Wf.

On the contrary, supply of the liquid mixture in which the IPA concentration is 50% or less to the substrate W replaces DIW adhering to the gaps between the patterns with the liquid mixture while suppressing the consumption amount of IPA. In this instance, the amount of IPA present in the gaps between the patterns is less than what would be present in replacing processing which uses IPA having the concentration of 100%. However, based on the evaluation result shown in FIG. 6, even when the IPA concentration is beyond 50%, the surface tension of the liquid mixture does not drop considerably, which means that one can not expect a significant reduction of the force destroying the patterns. That is, the consumption amount of IPA merely increases, and one can not expect a great enhancement regarding an effect on prevention of pattern destruction. Hence, setting the IPA concentration to 50% or less realizes effective prevention of destruction of the patterns while suppressing the consumption amount of IPA. Further, from such a viewpoint, it is desirable that the IPA concentration is from 5% to 35% and it is further desirable that the IPA concentration is from 5% to 10%.

Further, according to this embodiment, since the pre-drying step is executed before the drying step (spin drying), it is possible to prevent the liquid which composes the liquid layer 21 from remaining as droplets in the central section of the surface of the substrate W, becoming stripes of particles and forming watermarks on the substrate surface Wf during the drying step. In other words, while the substrate W rotates for removal of the liquid layer 21 adhering to the substrate surface Wf and drying (spin drying) of the substrate surface Wf, the closer the liquid which composes the liquid layer 21 is to the central section of the surface of the substrate W, less acted upon the liquid is by centrifugal force, and therefore, drying progresses from the edge section of the surface of the substrate W. When this occurs, droplets may remain from the central section of the surface of the substrate W to the periphery of the substrate W and run toward the edge of the substrate W and watermarks may be formed on the trails of the moving droplets. On the other hand, according to this embodiment, by forming the hole 22 in the central part of the liquid layer 21 in advance before the drying step and expanding the hole 22, the liquid which is present in the central section of the surface of the substrate W is removed, and hence, generation of watermarks is securely prevented. In particular, the liquid layer with DIW is formed on the substrate surface Wf after the replacing processing with the liquid mixture, and hence, stripe-like particles, watermarks and the like are likely to be formed. Because the contact angle with respect to the substrate surface Wf of DIW is larger than that of the liquid mixture. Therefore, execution of the pre-drying step described above is very effective for prevention of stripe-like particles, watermarks and the like.

### Second Embodiment

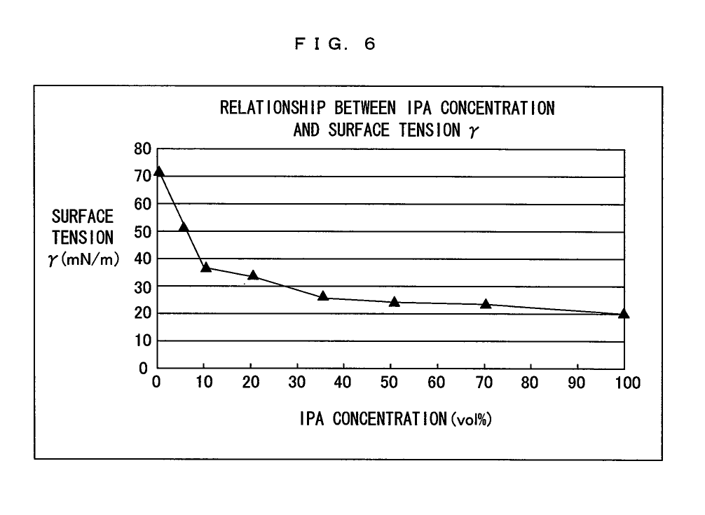

FIG. 7 is a diagram showing a second embodiment of a substrate processing apparatus according to the invention. A major difference of the substrate processing apparatus according to the second embodiment from that according to the first embodiment is that a blocking member 9 functioning as the “atmosphere blocker” of the invention is disposed at a position above the spin chuck 1. The other structures and operations are similar to those according to the first embodiment, and therefore, will merely be denoted at the same reference characters but will not be described.

The blocking member 9 is a disk-shaped member which has an opening in its central section and disposed at a position above the spin chuck 1. A lower surface (bottom surface) 9a of the blocking member 9 is a substrate-opposed surface which is opposed and approximately parallel to the substrate surface Wf, and the plane size of the blocking member 9 is equal to or larger than the diameter of the substrate W. The blocking member 9 is attached approximately horizontally to the bottom end of a rotation column 91 which is shaped approximately cylindrical, and an arm 92 extending in the horizontal direction holds the rotation column 91 so that the rotation column 91 can rotate about a vertical axis which penetrates the center of the substrate W. A blocking member rotating mechanism 93 and a blocking member elevating mechanism 94 are connected with the arm 92.

The blocking member rotating mechanism 93 rotates the rotation column 91 about the vertical axis which penetrates the center of the substrate W, in response to an operation command from the control unit 4. Further, the blocking member rotating mechanism 93 is structured so as to rotate the blocking member 9 at the approximately same rotating velocity as the substrate W and in the same rotating direction as the substrate W in accordance with the rotation of the substrate W held by the spin chuck 1.

The blocking member elevating mechanism 94 is capable of moving the blocking member 9 close and opposed to the spin base 15, and adversely moving the blocking member 9 away from the spin base 15 in response to an operation command from the control unit 4. To be more specific, activating the blocking member elevating mechanism 94, the control unit 4 makes the blocking member 9 ascend to a separated position above the spin chuck 1 during loading and unloading of the substrate W into and from the substrate processing apparatus. On the other hand, for predetermined processing of the substrate W, the control unit 4 makes the blocking member 9 descend to a predetermined opposed position (the position shown in FIG. 7) which is very close to the surface Wf of the substrate W which is held by the spin chuck 1. In this embodiment, the blocking member 9 remains at the opposed position when rinsing processing, replacing processing, liquid layer forming processing, and drying processing are executed to the substrate W.

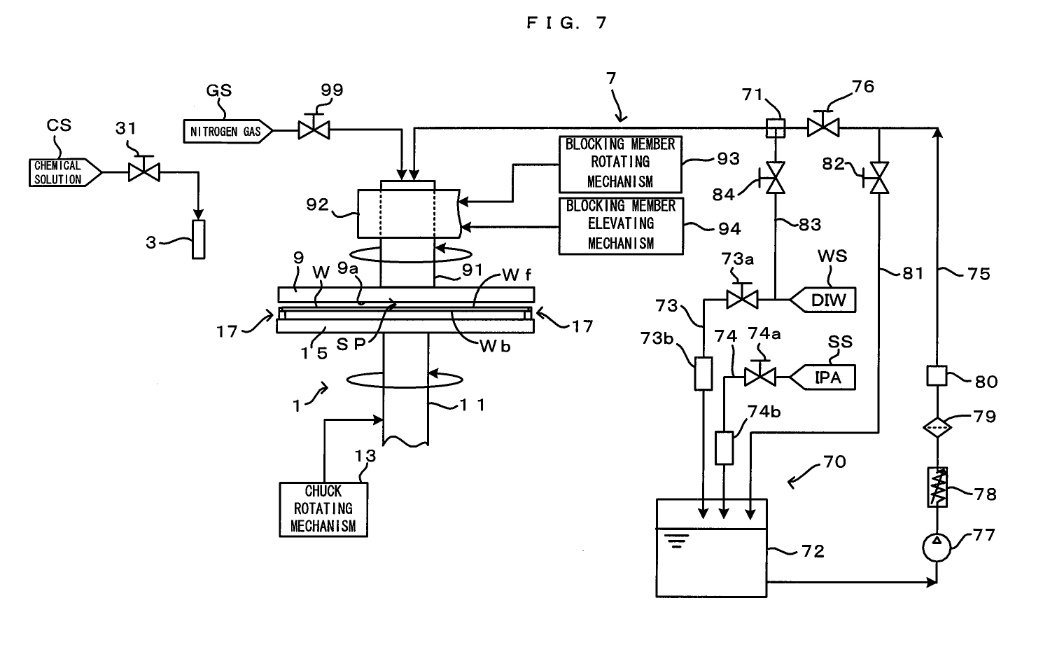

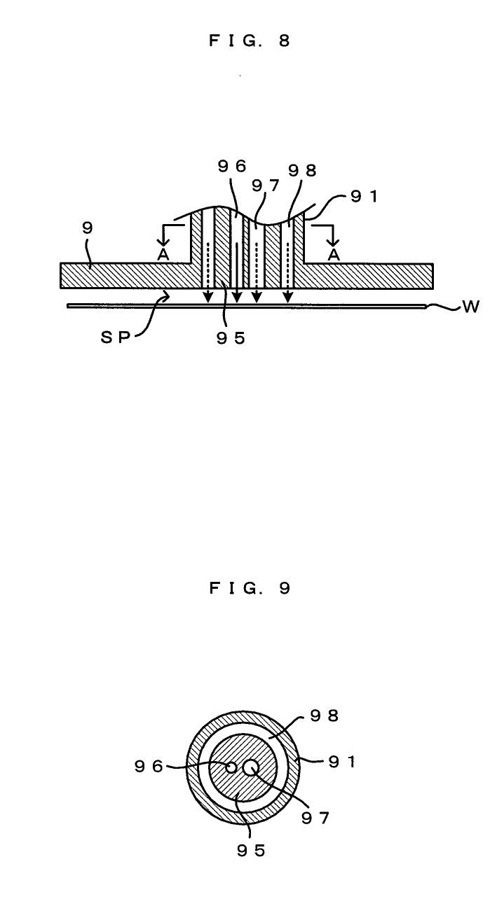

FIG. 8 is a longitudinal sectional view showing a main part of the blocking member equipped in the substrate processing apparatus shown in FIG. 7. FIG. 9 is a sectional view (transverse sectional view) taken on line A-A in FIG. 8. The rotation column 91 is hollow and an internal insertion shaft 95 is inserted through the rotation column 91. A liquid supplying path 96 is formed in the internal insertion shaft 95, and the bottom end of the liquid supplying path 96 faces the surface Wf of the substrate W which is held by the spin chuck 1 as a liquid discharging opening. The liquid supplying path 96 is connected with the liquid supply unit 7 so that when the liquid supply unit 7 supplies DIW and the liquid mixture (IPA+DIW), the liquid supplying path 96 selectively discharges DIW and the liquid mixture. The structure of the liquid supply unit 7 is similar to that according to the first embodiment. In this embodiment, the liquid supplying path 96 which supplies selectively the liquid mixture or DIW to the substrate surface Wf thus functions as the “replacing section” and the “liquid layer forming section” of the invention.

Further, a gas supplying path 97 is formed in the internal insertion shaft 95 beside the liquid supplying path 96, and the bottom end of the gas supplying path 97 is a gas discharging opening. The liquid discharging opening of the liquid supplying path 96 and the gas discharging opening of the gas supplying path 97 are opened adjacent to each other in the lower surface 9a of the blocking member 9. Further, a space part formed between an inner wall surface of the rotation column 91 and an outer wall surface of the internal insertion shaft 95 composes an outer gas supplying path 98, and the bottom end of the outer gas supplying path 98 is a ring-like gas discharging opening. To be more specific, the outer gas supplying path 98 is provided so as to surround the gas supplying path 97 in the blocking member 9 other than the gas supplying path 97 which discharges gas toward the central part of the substrate surface Wf. The gas supplying path 97 and the outer gas supplying path 98 are connected with the gas supplying source GS via an on-off valve 99, and it is possible to supply inert gas such as nitrogen gas or gas such as dry air to a space SP between the lower surface 9a of the blocking member 9 and the substrate surface Wf.

In the substrate processing apparatus having such a structure, the substrate W is cleaned in the following manner. That is, the chemical solution nozzle 3 supplies the chemical solution to the substrate surface Wf, whereby chemical processing is executed to the substrate W. Following this, the blocking member 9 is positioned to the opposed position from the separated position and is positioned adjacent to the substrate surface Wf. Then, the blocking member 9 is rotated with the rotation of the substrate W. In this state, the liquid supplying path 96 discharges DIW, thereby rinsing the substrate W (rinsing step), and subsequently, the liquid supplying path 96 discharges the liquid mixture, thereby replacing the rinsing liquid adhering to the substrate surface Wf with the liquid mixture (replacing step).

Next, the liquid supplying path 96 discharges DIW in place of the liquid mixture, thereby forming a puddle-like liquid layer 21 with DIW on the entire substrate surface Wf (liquid layer forming step). After that, the gas supplying path 97 discharges a nitrogen gas toward a central section of the substrate surface Wf, thereby forming a hole 22 in the central section of the liquid layer 21. That is, a nitrogen gas from the gas supplying path 97 pushes the liquid (DIW) present in the central part of the substrate surface Wf toward the circumferential part and removes the liquid from the central part. Further, the outer gas supplying path 98 discharges a nitrogen gas toward the vicinity of the center of the substrate surface Wf, thereby expanding thus formed hole 22 toward the edge of the substrate W and accordingly the dried region grows (pre-drying step). In this way, most of the liquid which composes the liquid layer 21 is removed from the substrate surface Wf. In this embodiment, the gas supplying path 97 and the outer gas supplying path 98 thus function as the “gas supplier” and the “gas blower” of the invention.

Subsequently, the control unit 4 increases the rotation speeds of the motors of the chuck rotating mechanism 13 and the blocking member rotating mechanism 93, and makes the substrate W and the blocking member 9 rotate at high speeds. The liquid mixture which is left adhering to the substrate surface Wf is consequently shaken off and accordingly the drying processing (spin drying) of the substrate W is executed (drying step). Further, during this drying processing, the space between the blocking member 9 and the substrate surface Wf is turned into a nitrogen gas atmosphere by supplying nitrogen gas from the gas supplying path 97 and the outer gas supplying path 98. This facilitates drying of the substrate W and shortens the drying time. Further, it is possible to reduce oxygen concentration in the atmosphere around the substrate W, and hence, it is possible to decrease elution of the substance-likely-to-be-oxidized into the liquid component adhering to the substrate surface Wf. It is thus possible to efficiently prevent generation of watermarks on the substrate surface Wf.

As described above, according to this embodiment, replacing processing with the liquid mixture and puddle-like liquid layer forming processing with DIW are executed before drying the substrate surface Wf which is wet with the rinsing liquid. Therefore, in a similar fashion to that according to the first embodiment, it is possible to prevent particles from adhering to the substrate surface Wf while preventing destruction of the patterns and generation of watermarks. Further, it is possible to suppress the consumption amount of IPA and reduce cost. Furthermore, drying processing is executed while the space SP between the blocking member 9 and the substrate surface Wf being turned into nitrogen atmosphere, whereby drying time is shortened and elution of the substance-likely-to-be-oxidized is suppressed. As a result, generation of watermarks can be effectively prevented.

### Others

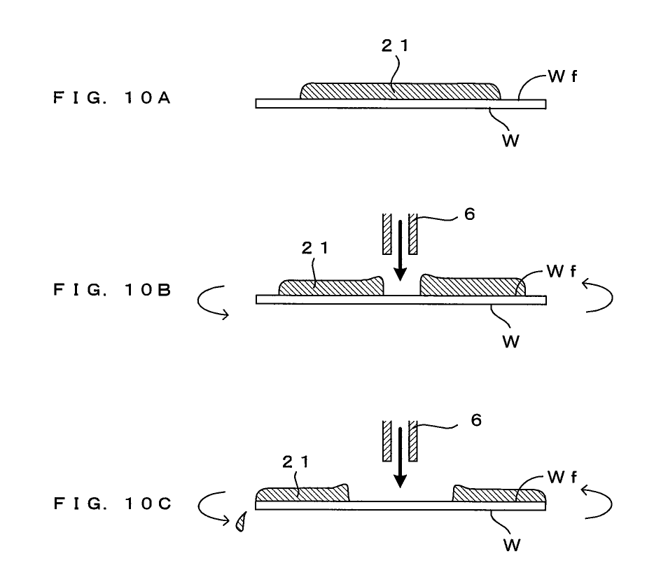

The invention is not limited to the embodiments described above but may be modified in various manners in addition to the embodiments above, to the extent not deviating from the object of the invention. For instance, in the above embodiments, the liquid layer is formed on the entire substrate surface Wf in the liquid layer forming step. However, the liquid layer may not necessarily be formed on the entire substrate surface Wf, but be formed on a part of the substrate surface Wf. In stead of the above first embodiment for instance, DIW may be discharged from the rinse nozzle 5 toward the central part of the substrate surface Wf, and the liquid layer (liquid film) 21 is formed on the central part of the substrate surface Wf (FIG. 10A). In this state, a nitrogen gas is blown from the gas nozzle 6 to the central section of the substrate surface Wf. In consequence, the liquid layer 21 is formed in a shape of a ring (FIG. 10B). And, by blowing a nitrogen gas continuously toward the substrate surface Wf, the ring-like liquid layer 21 gradually expands toward the edge of the substrate W from the central part of the substrate surface Wf (FIG. 10C). The liquid layer 21 with DIW formed on a part of the substrate surface Wf is moved gradually on the substrate surface Wf, whereby only the liquid mixture of the surface layer part is replaced with DIW all over the substrate surface and is removed from the substrate surface Wf.

Further, in the above embodiments, after execution of wet processing such as chemical processing and rinsing processing to the substrate W, replacing processing, liquid layer forming processing and drying processing are executed to the substrate surface Wf wet with the rinsing liquid inside the same apparatus. However, replacing processing and the subsequent processing may be separated from wet processing. That is, the apparatus which dries the substrate surface Wf wet with the rinsing liquid may be structured in a single piece.

In addition, in the embodiments above, the liquid mixture is generated by mixing the liquid (DIW) whose composition is the same as that of a processing liquid inside the cabinet part 70, but the method of generating the liquid mixture is not limited to this. For example, the organic solvent component may be mixed with the processing liquid, in an in-line fashion, on a liquid feeder path which is for feeding the processing liquid toward the nozzle (replacing section) to thereby generate the liquid mixture. Further, the liquid mixture generator such as the cabinet part is not limited to be provided inside the substrate processing apparatus. Instead, the liquid mixture, which is generated in other apparatus separately provided from the substrate processing apparatus, may be supplied to the substrate surface Wf via a nozzle which is disposed inside the substrate processing apparatus.

Further, in the embodiments above, although the liquid mixture (IPA+DIW) is used as a low surface tension solvent, IPA of 100% may be used instead. Furthermore, a solvent which includes a surface acting agent as an essential component may be used instead of the solvent which includes an organic solvent component such as IPA. Even if replacing processing is executed using such IPA of 100% or the solvent which includes a surface acting agent as an essential component, it is possible to prevent particles from adhering to the substrate surface Wf during drying the substrate by liquid layer forming processing which is executed after replacing process.

Further, in the embodiments above, although the substrate surface Wf which is wet with the rinsing liquid is dried, the invention is applicable also to a substrate processing method and a substrate processing apparatus which dry the substrate surface Wf which is wet with processing liquid other than the rinsing liquid.

Further, although the embodiments above use DIW as the rinsing liquid, the rinsing liquid may be a liquid which contains a component which does not exert a chemical cleaning effect upon the substrate surface Wf such as carbonated water (DIW+CO₂). In such an instance, the liquid mixture obtained by mixing the organic solvent component with a liquid (carbonated water) whose composition is the same as that of the rinsing liquid adhering to the substrate surface Wf may be used. Alternatively, the liquid mixture may be a mixture of the organic solvent component and DIW which is a principal component of carbonated water, while using carbonated water as the rinsing liquid. In essence, the liquid mixture may be a mixture of the organic solvent component and a liquid whose principal component is the same as that of the liquid adhering to the substrate surface Wf. Further, the rinsing liquid may be, other than DIW and carbonated water, hydrogen water, diluted ammonia water (having the concentration of around 1 ppm for instance), diluted hydrochloric acid, or the like.

### EXAMPLES

Next, examples according to the invention will be given. It is to be understood that the invention is not limited to the following examples, and that the variation may be made properly to the examples without departing from the scope suitable to the point described above and below, and those are included in the technical scope of the invention.

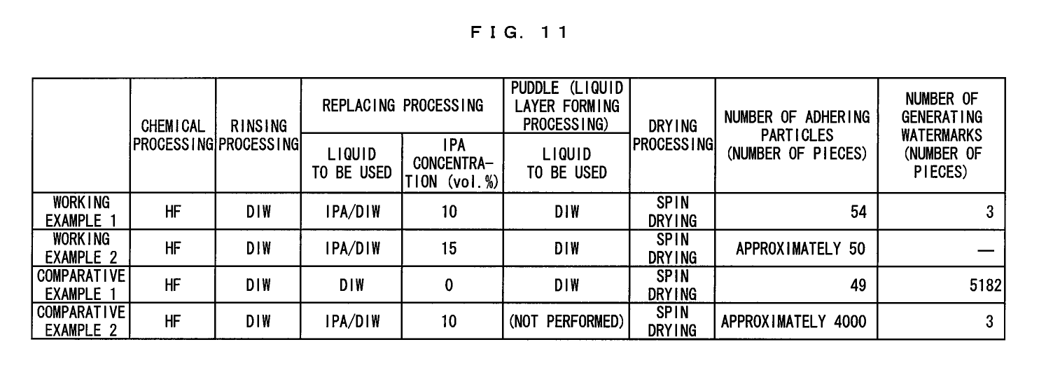

Working examples 1 and 2 according to the invention and comparative examples 1 and 2 for purposes of comparison only are described hereinafter with reference to FIG. 11. FIG. 11 is a drawing which shows conditions and results of working examples 1 and 2 and comparative examples 1 and 2.

A silicon wafer (whose diameter is 200 mm) on the surface of which patterns are not formed (that is, bare) is prepared. Then, a succession of cleaning processing is performed to a surface of the wafer and the number of adhering particles and the number of generating watermarks are evaluated. In the working examples 1 and 2 and the comparative example 1, chemical processing, rinsing processing, replacing processing, liquid layer forming processing, and drying processing are performed to the wafer. In the comparative example 2, except for liquid layer forming processing, only chemical processing, rinsing processing, replacing processing, and drying processing are performed to the wafer.

The processing conditions of chemical processing and rinsing processing are the same in the working examples 1 and 2 and in the comparative examples 1 and 2. To be more specific, after chemical processing (processing time is 60 seconds) is performed to the wafer using hydrofluoric acid as a chemical solution which is made up by mixing hydrogen fluoride and DIW in the volume ratio of 1 to 50, rinsing processing with DIW is performed. Further, the drying processing conditions are also the same in the working examples 1 and 2 and the comparative examples 1 and 2. That is, the wafer is dried (processing time is 30 seconds) by rotating in a condition that the rotation number is set to 1,000 rpm.

Next, the conditions of replacing processing are described. In the working examples 1 and 2 and in the comparative example 2, a liquid mixture (IPA+DIW) in which IPA and DIW are mixed is supplied (flow rate is 0.5 liter/min) to the wafer and accordingly replacing processing (processing time is 6 seconds) is performed. On the other hand, in the comparative example 1, DIW is supplied to the wafer successively to rinsing processing (flow rate is 1.5 liter/min). Meanwhile, the rotation number of the wafer is set to 1,000 rpm in all the examples.

Further, in liquid layer forming processing performed in the working examples 1 and 2 and in the comparative example 1, DIW is supplied to the wafer while the wafer is rotated in a condition that the rotation number is set to 50 rpm or less and accordingly a puddle-like liquid layer with DIW is formed on the entire surface of the wafer. The time required to form the liquid layer was 3 to 4 seconds.

Then, the surface of the wafer to which the succession of cleaning processing is performed is evaluated using the wafer defect inspection apparatus manufactured by KLA-Tencor company, and the number of adhering particles and the number of generating watermarks are measured. Meanwhile, the number of adhering particles before cleaning processing (that is, the initial value of the number of adhering particles) is approximately 50.

As shown in FIG. 11, although IPA concentration in replacing processing is different when the working example 1 is compared with the working example 2, according to both examples, good results are obtained regarding the number of adhering particles and the number of generating watermarks. To be more specific, in the case where IPA concentration in replacing processing is increased from 10% (working example 1) to 15% (working example 2), the number of adhering particles does not change and the adhesion of particles to the wafer surface is suppressed. On the other hand, in the case where the liquid layer is formed with only DIW without performing replacing processing with the liquid mixture after rinsing processing (that is, the comparative example 1), although the adhesion of particles is suppressed, the generation of watermarks can not be prevented. Meanwhile, in the case where liquid layer forming processing is not performed after replacing processing with the liquid mixture (that is, the comparative example 2), although the generation of watermarks is suppressed, a lot of particles adhere to the wafer.

The present invention is applicable to a substrate processing method and a substrate processing apparatus which performs drying processing to a surface of substrates in general including semiconductor wafers, glass substrates for photomask, glass substrates for liquid crystal display, glass substrates for plasma display, substrates for FED (Field Emission Display), substrates for optical disks, substrates for magnetic disks, substrates for magnet-optical disks, etc.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing method of drying a substrate surface which is wet with a processing liquid, the method comprising:
a replacing step of supplying a low surface tension solvent whose surface tension is lower than the processing liquid to the surface of the substrate which is held approximately horizontally to thereby replace the processing liquid adhering to the substrate surface with the low surface tension solvent;
a liquid layer forming step of supplying, after the replacing step, a liquid whose composition or principal component is the same as that of the processing liquid to thereby form a puddle-like liquid layer with the liquid on the substrate surface; and
a drying step of removing the liquid layer from the substrate surface to thereby dry the substrate surface.

2. The substrate processing method of claim 1, wherein at the liquid layer forming step, the puddle-like liquid layer with the liquid is formed on the entire substrate surface.

3. The substrate processing method of claim 1, wherein
at the replacing step, the low surface tension solvent is supplied to the substrate surface while the substrate is rotated at a first rotating velocity, and
at the liquid layer forming step, the liquid layer is formed on the substrate surface in a condition that the rotation of the substrate is stopped or that the substrate is rotated at a second rotating velocity which is lower than the first rotating velocity.

4. The substrate processing method of claim 1, wherein at the replacing step, a liquid mixture is supplied to the substrate surface as the low surface tension solvent, the liquid mixture being a mixture of a liquid, whose composition or principal component is the same as that of the processing liquid, and an organic solvent component which gets dissolved in the liquid and reduces its surface tension.

5. The substrate processing method of claim 4, wherein the percentage by volume of the organic solvent component contained in the liquid mixture is 50% or less.

6. The substrate processing method of claim 5, wherein the percentage by volume of the organic solvent component contained in the liquid mixture is from 5% to 35%.

7. The substrate processing method of claim 6, wherein the percentage by volume of the organic solvent component contained in the liquid mixture is 10% or less.

8. The substrate processing method of claim 1, wherein at the drying step, the substrate surface is dried by shaking the liquid which composes the liquid layer formed on the substrate surface off while rotating the substrate.

9. The substrate processing method of claim 1, further comprising a rinsing step of supplying, before the replacing step, a rinsing liquid to the substrate surface to thereby perform rinsing processing, wherein
at the replacing step, the rinsing liquid, which adheres to the substrate surface and serves as the processing liquid, is replaced with the low surface tension solvent.

10. The substrate processing method of claim 1, wherein the drying step is performed in an inert gas atmosphere.

11. The substrate processing method of claim 8, further comprising a pre-drying processing step, which is executed after the liquid layer forming step but before the drying step, of blowing a gas toward a central section of the substrate surface to thereby form a hole in a central section of the liquid layer and enlarge the hole toward the periphery edge of the substrate.

12. The substrate processing method of claim 1, wherein at the liquid layer forming step, after the puddle-like liquid layer with the liquid is formed at a central section of the surface of the substrate, a gas is blown toward the central section of the surface of the substrate to thereby form the liquid layer in a shape of a ring and enlarge the ring-like liquid layer toward the periphery edge of the substrate from the central section of the surface of the substrate.

13. A substrate processing apparatus, comprising:
a substrate holder which holds a substrate approximately horizontally in a condition that a substrate surface which is wet with a processing liquid is directed toward above;
a replacing section which supplies a low surface tension solvent whose surface tension is lower than the processing liquid to the substrate surface to thereby replace the processing liquid adhering to the substrate surface with the low surface tension solvent; and
a liquid layer forming section which supplies a liquid, whose composition or principal component is the same as that of the processing liquid, to the substrate surface to which the low surface tension solvent adheres to thereby form a puddle-like liquid layer with the liquid on the substrate surface, wherein
the liquid layer is removed from the substrate surface to thereby dry the substrate surface.

14. The substrate processing apparatus of claim 13, further comprising a rotating unit which rotates the substrate which is held by the substrate holder at a predetermined rotating velocity, wherein
the replacing section supplies the low surface tension solvent to the surface of the substrate which is rotated by the rotating unit at a first rotating velocity, and
the liquid layer forming section forms the liquid layer on the surface of the substrate in a condition that the rotation of the substrate is stopped or that the substrate is rotated by the rotating unit at a second rotating velocity which is lower than the first rotating velocity.

15. The substrate processing apparatus of claim 14, wherein the rotating unit shakes the liquid which composes the liquid layer formed on the substrate surface off while rotating the substrate to thereby dry the substrate surface.

16. The substrate processing apparatus of claim 13, further comprising:
an atmosphere blocker which has a substrate-opposed surface capable of facing the substrate surface and is disposed spaced apart from the substrate surface while the substrate-opposed surface being opposed to the substrate surface; and
a gas supplier which supplies an inert gas to a space between the substrate-opposed surface and the substrate surface.

17. The substrate processing apparatus of claim 15, further comprising a gas blower which blows a gas toward a central section of the surface of the substrate which is held by the substrate holder, wherein
the gas blower blows the gas toward the central section of the surface of the substrate to form a hole in a central section of the liquid layer and to enlarge the hole toward the periphery edge of the substrate, after the liquid layer is formed by the liquid layer forming section but before drying the substrate surface.
